(19) United States
(12) Patent Application Publication
(10) Pub. No.: US 2008/0262895 A1
(43) Pub. Date: Oct. 23, 2008

(54) BUSINESS RESILIENCE SYSTEMS AND METHODS

(75) Inventors: Douglas F. Hofmeister, Evanston, IL (US); Russell W. Beverly, West Hartford, CT (US); Robert S. Emmel, Naperville, IL (US); Mary Efthimiou, Chapel Hill, NC (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: ACCENTURE GLOBAL SERVICES GMBH, Schaffhausen (CH)

(21) Appl. No.: 12/038,450

(22) Filed: Feb. 27, 2008

Related U.S. Application Data
(60) Provisional application No. 60/912,603, filed on Apr. 18, 2007.
(60) Provisional application No. 60/912,865, filed on Apr. 19, 2007.

(51) Int. Cl. G06Q 10/00

(52) U.S. Cl. 705/9; 705/7; 705/8; 705/11

(57) ABSTRACT

Systems and methods are provided as pieces of the end-to-end resilience capability such as impact assessments, continuity plans and monitoring/alert technologies. Various disclosed systems and methods may be used to leverage technology in conjunction with consulting services to optimize the creation, maintenance and execution of business resilience. Select systems and methods utilize a diagnostic risk atom tool to connect an enterprise risk assessment that can be associated with a risk mitigation strategy and action plans that are triggered based on alerts and notification methods tied to an individual's role, responsibility and assets that they manage.

This application claims priority of the provisional patent application U.S. Patent Application Ser. No. 60/912,603 filed on Apr. 18, 2007 and U.S. Patent Application Ser. No. 60/912,865 filed on Apr. 19, 2007, the contents of which are incorporated by reference.

### FIELD OF THE INVENTION

The present invention relates to systems and methods relating to diagnostic tools that may connect an enterprise risk assessment that can be associated with a risk mitigation strategy and action plans that are triggered based on alerts and notification methods tied to an individual's role, responsibility and the assets they manage.

### BACKGROUND

Traditional business continuity, risk management, and supply chain management initiatives are proving inadequate. Programs often are not centrally managed or coordinated, business resilience tools and processes are incomplete, and existing programs have not kept pace with accelerating growth in risk. These programs are typically fragmented, with overlapping components, moderate response time, some integrated access to information, moderate collaboration capabilities, and moderate risk awareness. Historically, these business processes would have to combine enterprise risk management, supply chain management; disaster recovery; health and safety and data security. These systems were historically incomplete. Even more current systems that utilize supply chain management; crisis management and enterprise risk management still suffer the disadvantage of being fragmented.

In contrast, systems and methods disclosed herein may provide a centralized solution with unified presentation of data, instant response time, robust reporting capabilities, fully integrated access to information, inherent collaborative capabilities, and on-demand risk status and readiness assessments. Other desired qualities include the unified presentation of data; instant response time; robust reporting capabilities; fully integrated access to information; and inherent collaborative capabilities

### SUMMARY

In accordance with one aspect of the present invention, a risk atom is provided. The risk atom includes inter-related information that may assist an entity, such as a business, define the process data points to be monitored, the impact upon the business if those data points do no meet specified thresholds and the business' response to a situation where the data point is affected.

In another aspect of the invention, the risk atom includes a plurality of orbits. In one embodiment, the risk atom comprises four orbits. The first orbit may relate to information regarding the process data point and whether it is reported manually or in real time. The second orbit may relate to the business functions and the accompanying resources. The third orbit may relate to the threats and impacts that are implicated as a result of the data. Finally, the fourth orbit may convey information regarding the risk elements and responses thereto.

### BRIEF DESCRIPTION OF THE DRAWINGS

The present invention is illustrated by way of example and not limited in the accompanying figures in which like reference numerals indicate similar elements and in which:

FIG. 1 shows a flowchart demonstrating definition and development of business resilience in accordance with an embodiment of the invention.

FIG. 2 shows a business resilience matrix in accordance with an embodiment of the invention.

FIG. 3 shows a process of business resilience in accordance with an embodiment of the invention.

FIG. 4 shows an exemplary Risk Atom in accordance with an embodiment of the invention.

FIG. 5 shows examples of information orbits within the Risk Atom in accordance with an embodiment of the invention.

FIG. 6 shows each matrix intersection that may be made up of multiple monitored data points in accordance with an embodiment of the invention.

FIG. 7 shows a third orbit of the exemplary Risk Atom in accordance with an embodiment of the invention.

FIG. 8 shows a fourth orbit of the exemplary Risk Atom in accordance with an embodiment of the present invention.

FIG. 9 shows an exemplary use of a Risk Atom in accordance with an embodiment of the invention.

FIG. 10 shows a systems view of a Risk Atom in accordance with an embodiment of the present invention.

FIG. 11 shows how an overall monitoring system may continuously change in accordance with an embodiment of the present invention.

### DETAILED DESCRIPTION

The term “business resilience” is used herein to describe one specific embodiment of the present invention. It is to be appreciated that other embodiments of the present invention are disclosed throughout the disclosure. Business resilience as used herein is typically composed of companies that provided pieces of the end-to-end “resilience” capability. These capabilities may include, for example, impact assessments, continuity plans and monitoring/alert technologies. Existing offerings treat front-end and post-implementation business resilience processes as distinct and do not recognize the value of approaching business resilience simultaneously or holistically. It is observed that technology is not being fully leveraged in conjunction with consulting services to optimize the creation, maintenance and execution of business resilience.

Business resilience embodiments of the present invention provide the opportunity for advancement in process and technology. In one embodiment, a diagnostic tool patterned after the “risk atom” may be utilized to connect an enterprise risk to an assessment that can be associated with risk mitigation strategy and action plans that are triggered based on alerts and notification methods tied to an individual's role, responsibility and the assets they manage.

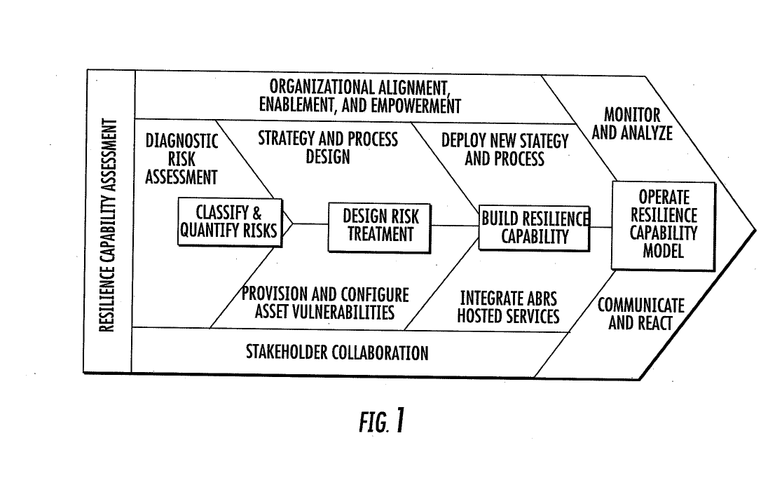

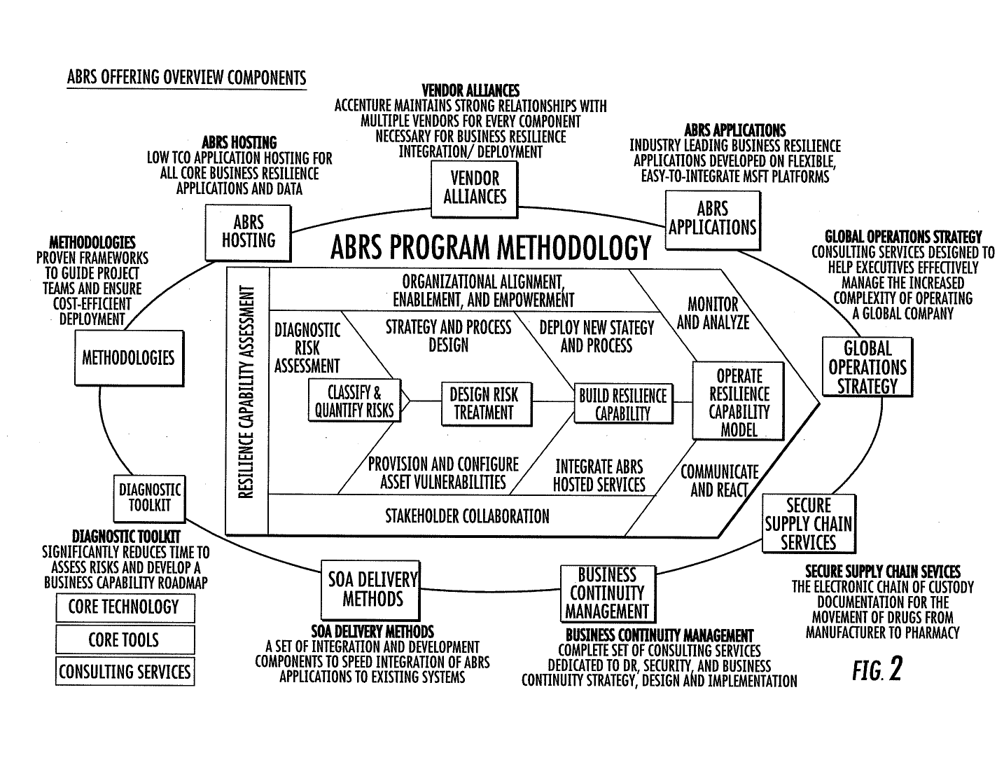

Business resilience in accordance with embodiments of the present invention enables clients to proactively protect shareholder value against the adverse impact of business disruption at any scale. As shown in FIG. 1, business resilience may include consulting and managed services that facilitate the definition and development of resilience capabilities. According to one illustrative example, it may be delivered in four phases:

Phase 1 may comprise a web-enabled risk assessment that spans the enterprise and, in some embodiments, extended supply/value chain, including, for example, government and community stakeholders.

Phase 2 may comprise a structured methodology to prioritize risks and develop a Business Unit (BU) or Enterprise risk mitigation strategy based on its contribution to shareholder value.

Phase 3 may comprise the deployment of managed services that enable the risk mitigation processes, including monitoring, notification and automated action plan dissemination and decision support.

Phase 4 may comprise an on-going self-assessment and action planning capability for continuous improvement.

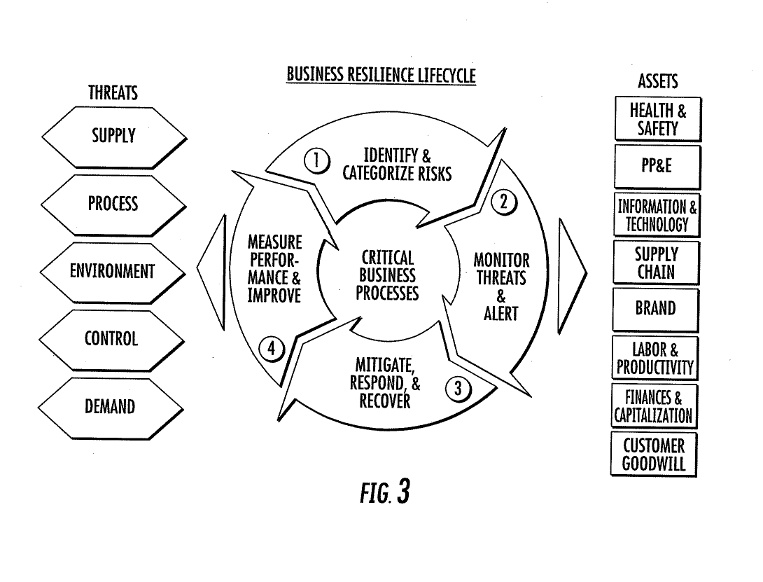

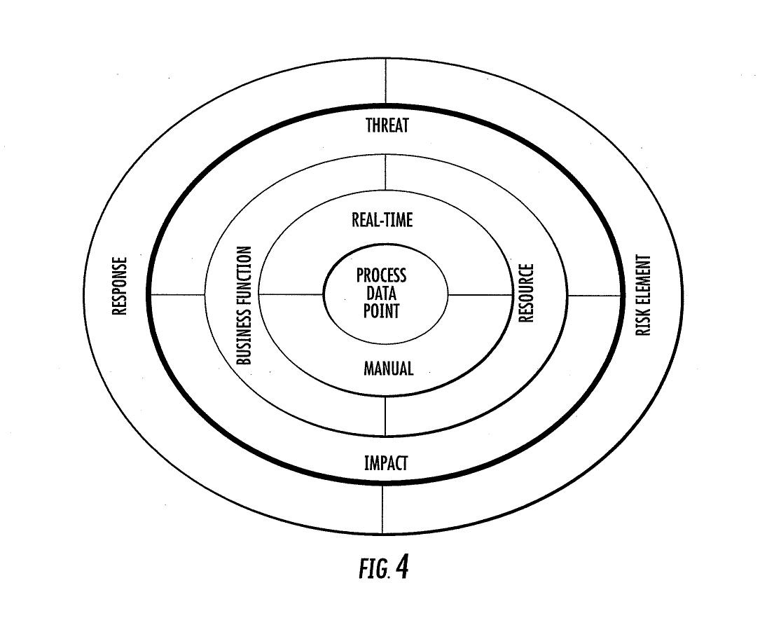

As shown in FIG. 2, a business resilience matrix in accordance with embodiments of the present may categorize risk by a comparison between an organization's assets and threats. While organizations may vary across industries, the business resilience framework may be used to offer a common language. Within the illustrative matrix, threats to an organization and critical assets are classified according to an established methodology. The framework of an embodiment incorporating such a matrix offers flexibility for an organization to focus on identified “pain points” that are of a certain threshold of interest or value as the first part of the business resilience effort, and then move to other areas as prioritized by leadership. It is further contemplated that these “pain points” may be predetermined or may be selected based on other intervening factors. Business cases are developed to address these key areas of vulnerability, and ultimately mitigation solution development is tied to business strategy. Proactive monitoring and notification of threats and adverse trends is a component of the business resilience model. Capabilities provide real-time information to key personnel regardless of location or time zone, along with automated action plans focused on averting disruption and/or minimizing its impact. These resilience capabilities also include identification and adoption of chain-of-command compliance and escalation interfaces to enterprise, governmental and community stakeholders.

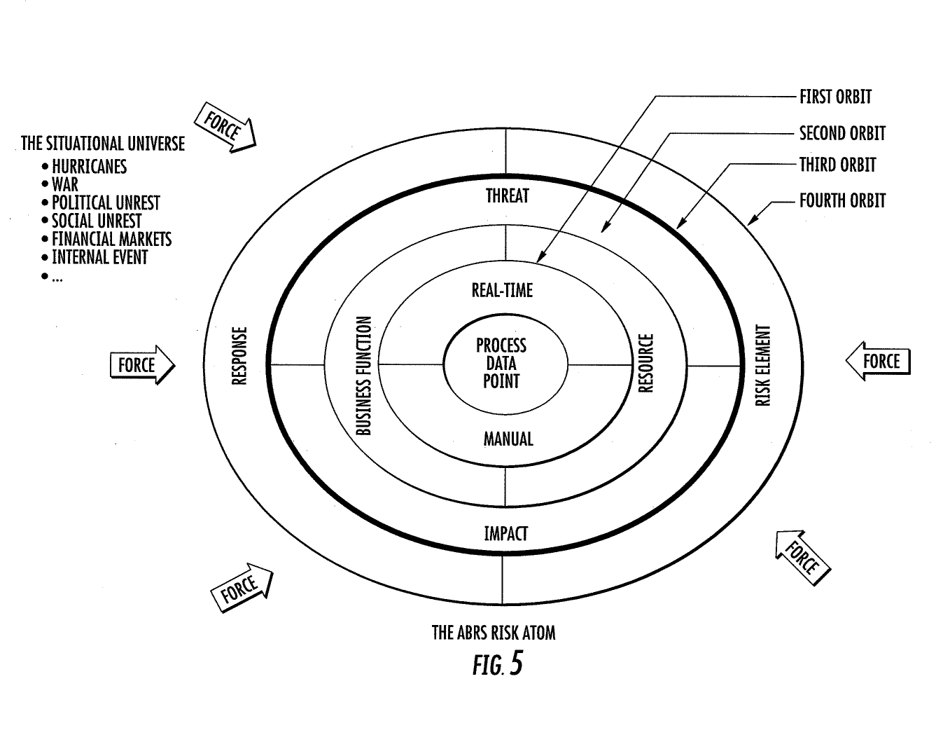

As better understood in reference to FIG. 3, the business resilience analysis process may serve to: identify areas where the selected businesses are most susceptible to threats; quantify the potential financial impact of associated vulnerabilities for key stakeholders; and establish a resilience program to address key vulnerabilities that considers financial exposure, investment requirements, cultural fit, and time-to-competency/closure.

The outcomes of the initial assessment may be utilized to guide the approach(es) for risk categorization and treatment, including, for example, the consideration of frequency and scale of threats. Once the tools are in place to manage and monitor threats and risks, an organization is enabled with real-time notification and various communication and collaboration capabilities across the technological and operational infrastructures. The organization is also enabled with the tools to understand the extent of a threat or disruption to operations, thus an organization can effectively mitigate the threat or risk, respond as determined, and restore and improve operational capabilities. According to certain embodiments, threat information and response rules may be updated in the database to meet the needs of an enterprise. In one embodiment, the updates may be provided in substantially real-time. Another component of the resilience lifecycle provides a critical capability of performance measurement and lessons learned for future mitigation and response.

In accordance with embodiments of the present invention, a business resilience lifecycle management approach may provide a continuous improvement loop aimed at supporting the critical business processes and the enterprise assets necessary for the maintenance of revenue, earnings and/or shareholder value. Additionally, business resilience design framework provides the construct to introduce substantial new levels of automation and on-line services aimed at streamlining risk management. The design supports the core business resilience processes. For example: risk assessment/diagnostic that builds a business case for each risk in the scope of the assessment; profiling the people, assets, sites and/or supplies that are impacted by each risk area addressed; enabling the impacted people to define the actions best suited to mitigating the risk and recovery from incidents when they occur; continuous monitoring of the environment and automated notification and response based on alert thresholds set by the business and personnel affected; communication and collaboration tools to identify and coordinate the actions of all stakeholders, with knowledge of each of the key assets, management and critical information required to quickly and efficiently manage, respond and recover; tracking and financial reporting and comparing current plans and ongoing risk mitigation activities to industry best practices.

An integrated business resilience capability will generate tangible, bottom-line benefits to the organization. These benefits are related to the overall value framework for an enterprise and are measurable over time. Business resilience framework and methodologies address issues for clients, such as managing and mitigating the impact and duration of disruptions, risk management efficiency, and capital efficiency of such programs.

Currently, many organizations employ traditional Business Continuity and Risk Management capabilities, which are characterized by fragmented components that do not sufficiently meet their demands. Business resilience as implemented through select embodiments of the invention, however, provides the holistic approach to risk management that organizations can adopt in order to maintain persistence in earnings. Accordingly, business resilience may be utilized to deliver the following fundamental value proposition to clients: reduction in event/emergency management infrastructure and support costs by an estimated 50% to 75%; avoidance of outage and recovery costs through increased incident prevention; mitigation of the impact of a business disruption; reduction in insurance exposure; facilitate compliance with government legislation/regulation and industry standards at no additional cost; ready integration of compliance measures and government reporting requirements; automatic integration with Federal and regional emergency escalation processes; an estimated 5% to 20% improvement in supply chain and internal operational efficiencies (as applicable); competitive advantages leading to revenue growth.

Quantifiable metrics that organizations can use to determine the value of implementing business resilience systems and methods to the bottom line include: the number of average disruptions to operations or service to customer; average cost to the business per disruption; mean time to recover from disruption and return to steady state; total administrative costs for risk management employees; cost as a percentage of asset value protected; risk premium of share price versus peers (by industry). One skilled in the art with the benefit of this disclosure will appreciate that other discernable factors could be used to measure implementation success depending on the specific application of the business resilience system.

Embodiments of several business resilience systems and methods in accordance with the present invention are capable of reducing the magnitude and duration of major business disruptions over time in several key areas. Risks may be continuously evaluated and managed centrally and 24/7 monitoring and alerting capabilities provide early warning detections for any possible disruptions of business operations. Early detection equips the right individuals or groups of individuals with the information they need to react to a situation, executing according to pre-determined collaboration and action plans. Embodiments of the business resilience systems and methods are able to recover rapidly from the disruption as planned, and performance metrics are subsequently reviewed and used to make improvements in preparation for the next disruption.

Multiple components of the resilience system may be combined to provide the building blocks that drive the creation of the services, monitoring solutions and determine the actions to be taken upon a disaster. One component, a risk atom, as used in conjunction with the systems and methods of the present invention, may be comprised of various inter-related and continually moving and interacting components that are arranged in orbits surrounding a process data point (PDP) and help a business organization maintain resilient processes through an effective resource response to direct and indirect threats manifested by some preceding event(s). This approach helps an organization in numerous ways, including, but not limited to: better identify, quantify and respond to risk at the business process level; define the Risk Atoms that are appropriate to a specific business process (a business process may contain one or multiple Risk Atoms); identify and quantify those events and threats that could “force” the movement of a Risk Atom across identified and calculated performance measure thresholds over time; identify and quantify resource responses to avoid, mitigate, transfer or recover from the impact of a threat on a Risk Atom; quantify the level of threat impact that would “force” the Risk Atom to traverse through various performance level thresholds; determine how to identify and quantify the overall level of risk to a Risk Atom, business process or enterprise and set the stage for the establishment of an “early warning” approach that would enable an organization to respond to threats and their impact before a catastrophic situation materialized. Those skilled in the art upon review of this disclosure will readily appreciate that the Risk Atom and related conceptions may be applied to all business processes and is applicable to almost any “system” that must be resilient.

The exemplary Risk Atom as shown in FIG. 4 is comprised of inter-related information “orbits” that may be utilized to help a business define the process data points to be monitored and the impact upon the business if those data points do meet specified thresholds based on the process data point. The exemplary Risk Atom comprises four orbits as provided below:

First Orbit, the Process data point (PDP)—the nucleus—real time and manual reporting; Second Orbit: business functions and accompanying resources; Third Orbit: Threats and impacts and Fourth Orbit: Risk elements and responses. As will be readily understood by those skilled in the art upon review of this disclosure, more or less orbits may be utilized. For example, it is contemplated that certain applications may not require all four orbits to process, evaluate and mitigate a data point. In other instances, it may be appropriate to use more than four orbits.

According to exemplary systems and methods of the present invention, one or more PDPs that are a business process “tipping” point are identified. Further, the driving force(s) of business decisions are identified to prevent, avoid or mitigate impact from an event.

As utilized throughout this disclosure, a Process Data Point (PDP) is a Key Performance Indicator (KPI) or Business Process Influencer (BPI) that could have a direct and negative impact to a company's “bottom line” if that KPI or BPI significantly missed performance targets. For example, in the shoe industry, a BPI may be the number of days it takes for a container ship to transport the raw materials used in making the shoes to the closest port in the U.S. If the actual number of shipping days significantly exceeds the targeted number of days, the manufacturing plant may exhaust its supply of required raw materials and have to shut down until the new shipment of raw materials arrive, thereby drastically cutting production and having a decidedly negative impact on the organization's bottom line. It is to be appreciated that a process data point could be different for any industry and therefore will vary from application to application.

A PDP may be measured and monitored on a Manual (e.g., typically requires a human to enter, record and/or track data) or Real-time basis (e.g., system-based output) and may or may not be unique to an industry, client-type, resource or business process.

A business process represents those discrete business processes that an organization wants to make more resilient such as vendor payment, product manufacturing, and so forth.

A resource defines which one of the six resource categories (people, process, technology, network, data, facilities) a PDP falls into.

Threats may be segregated into environmental, supply, demand, process or controls groupings (these are generally accepted industry groupings) and are typically, but not always, proceeded by an event. For example, an earthquake can be an event, whereas a tsunami can be a threat. Again, threats can be industry specific, and that one threat may have an impact on one industry, that same threat may have no impact on another industry. For example, an oil spillage may have a huge impact on the price of gasoline, whereas that same spillage may have virtually no impact on the price of soybeans.

Impacts represent the financial (monetary), tangible and/or intangible impact to the business should a threat materialize because of a preceding event thereby causing the Risk Atom to “move” from its stasis or equilibrium point through a performance measure threshold.

The Risk Element identifies those elements of the business that an organization wishes to “guard” in order to protect things like customer goodwill, labor productivity, market capitalization or brand (for example)—things that could be irrevocably destroyed or have a severe impact on the organization's external standing in the business community if the organization was not prepared and/or resilient. A risk element may or may not be unique to a particular organization. A single Risk Atom may encompass multiple risk elements. In addition, there may be multiple Risk Atoms within a single organization risk element.

Response defines the activities that a business will perform in order to respond to an identified and manifested threat that causes the Risk Atom to “move” across performance measure thresholds over time. A particular response may be enacted to avoid, mitigate, transfer or recover from a particular situation. Each response may also encompass activities in several different areas, such as, for example, one or all of the following areas: people, process, technology, network, data and facilities.

FIG. 5 shows that within the Risk Atom, the information orbits may continually interact with other based upon the business direction and forces from the universe. To maintain a resilient business process, an organization must continually monitor, analyze and react to situational forces. Thus, a business must continually manage the situational forces to maintain resilience and keep itself in equilibrium. Those forces could be any external factor that may have an impact on that particular industry whether it is a hurricane, war, political unrest, social unrest, financial market or even an internal event.

If, for example, one force becomes too strong and is not foreseen or well managed, the business will fall out of equilibrium and open itself up to an increased level of risk whose negative manifestation may be significant and long lasting. An organization is deemed to be resilient if it can monitor and react to situational forces in a timely and controlled manner. It is possible, then, for the Risk Atom to fall out of equilibrium and not stop falling until a “response” has been initiated to avoid or mitigate the impact from the threat, transfer the financial impact from a threat through an insurance instrument or recover from a catastrophic situation brought on by a manifested threat that is not responded to early enough.

Defining a particular Risk Atom begins with identifying those PDPs that can be monitored to assist the business in defining, controlling and reacting to risk. At the basic particle level of a business, PDPs are identified that can be monitored to assist the business in defining and controlling risk.

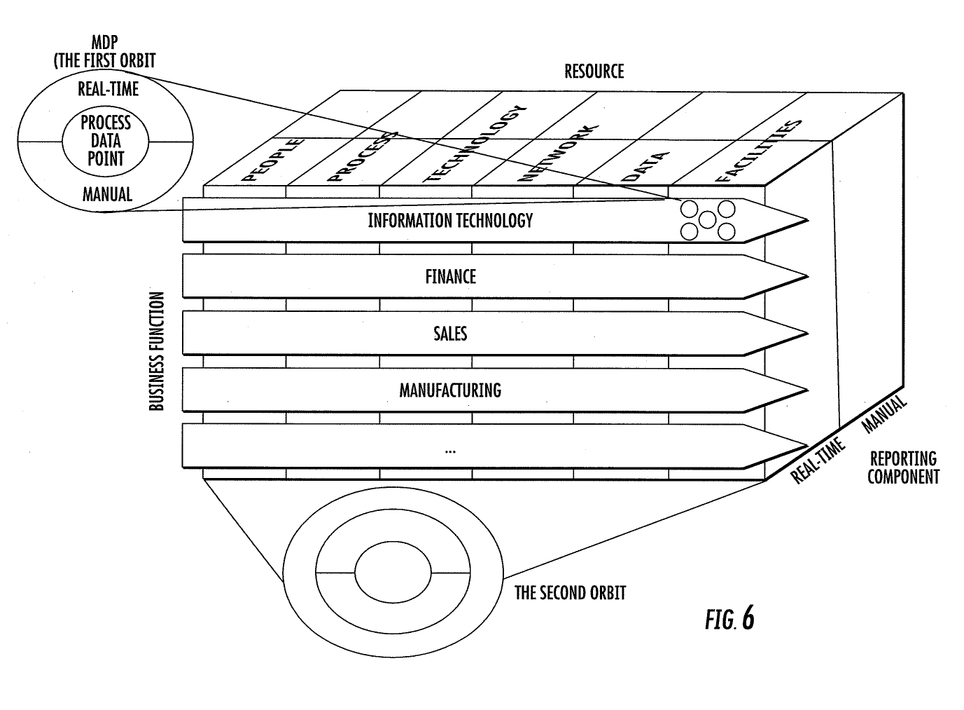

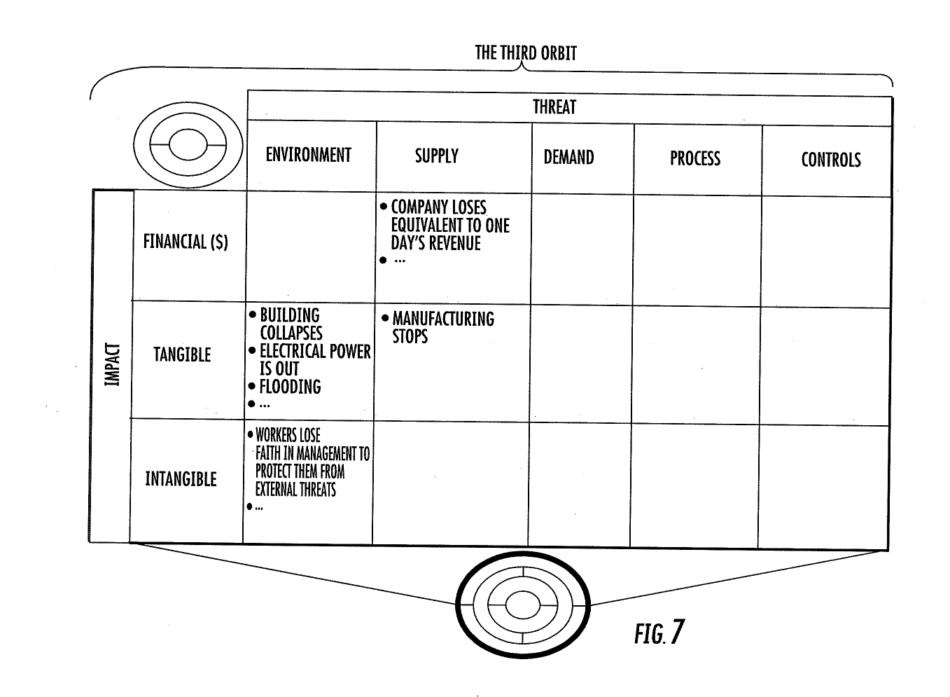

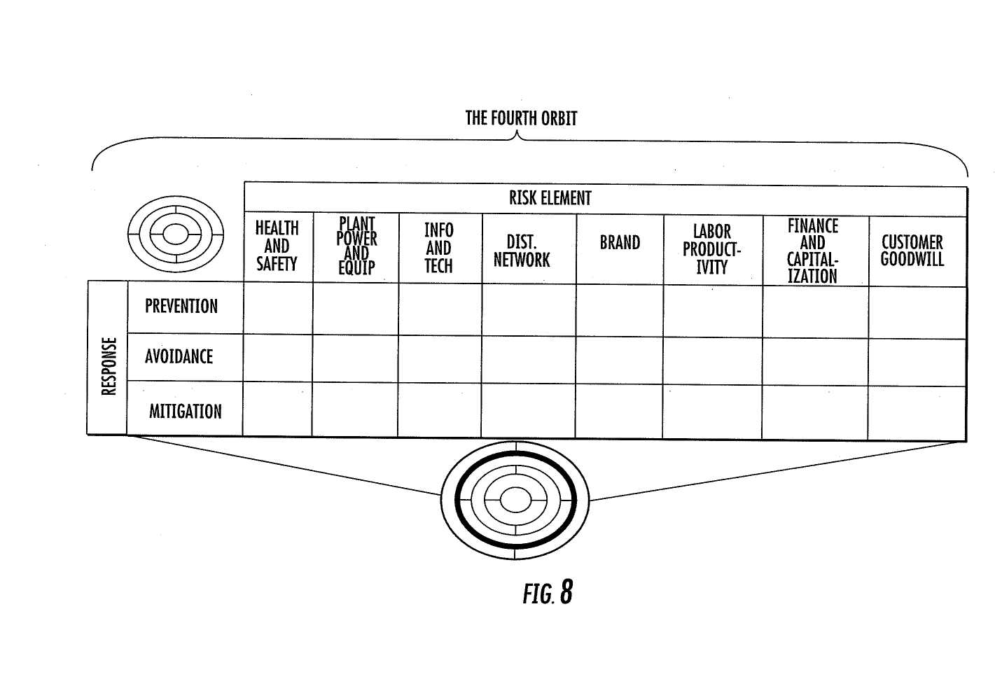

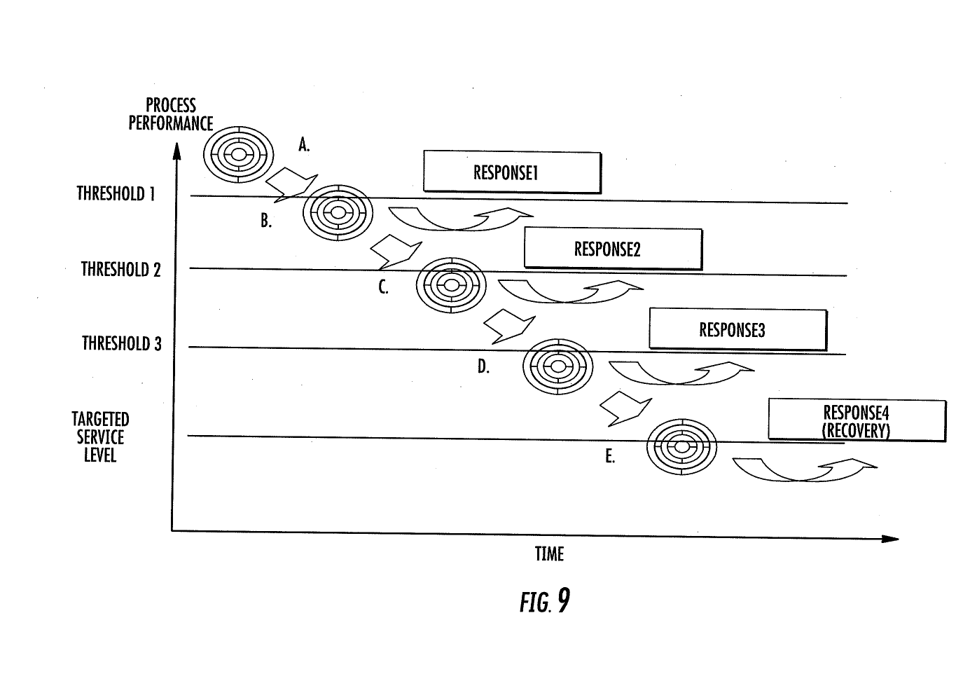

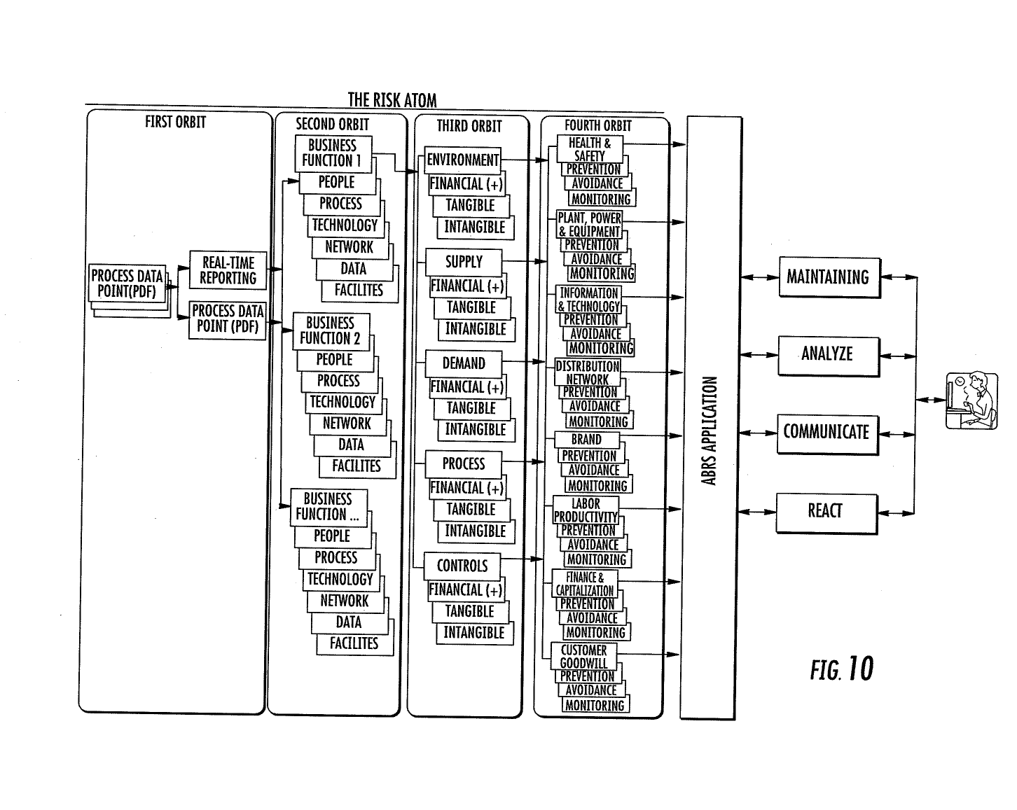

As seen in FIG. 6, each matrix intersection may be made up of multiple monitored data points (MDPs—a PDP that has had its real-time or manual monitoring capabilities defined) that reflect the business function in which it resides and the resource group it represents. Not every business function, however, will necessarily have an MDP. An MDP is a unique process data point (PDP) within the first orbit of the Risk Atom that can report its status via either real time or manual means and may or may not be unique to any industry, client type resource or business function. Of the thousands of possible data points used to run a business, there are a select few that would qualify as a PDP and have the capability to directly impact the business. For example, the “first orbit” encompasses an MDP (monitored data point) that is a unique PDP that reports its status through real-time (automated) or manual means. The “second orbit” is formed when a PDP is “wrapped” by its corresponding Reporting Component (first orbit) and the corresponding Business Function and Resource.

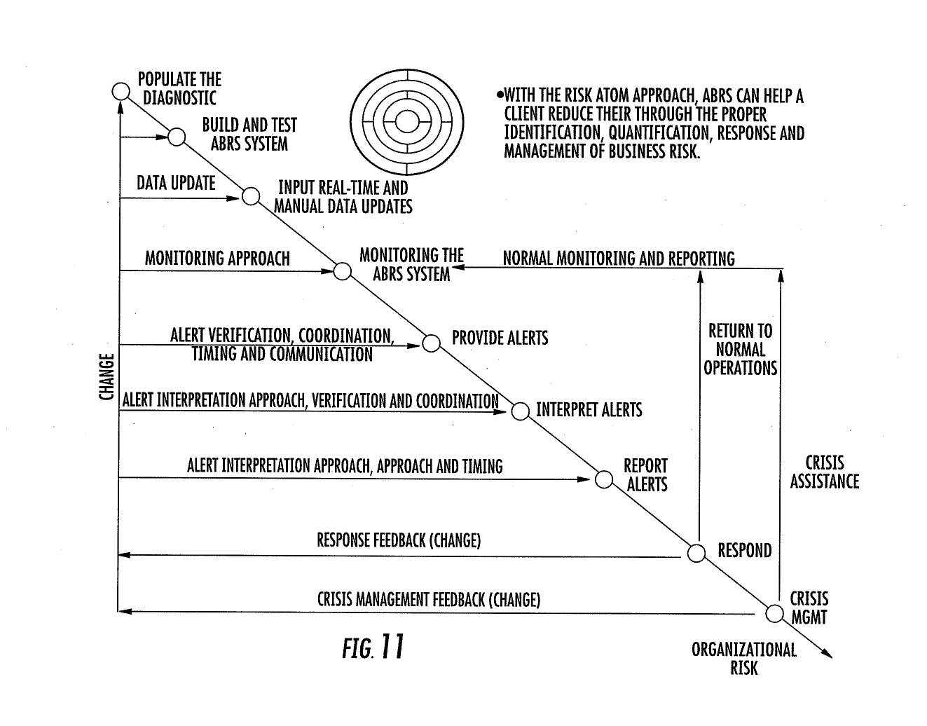

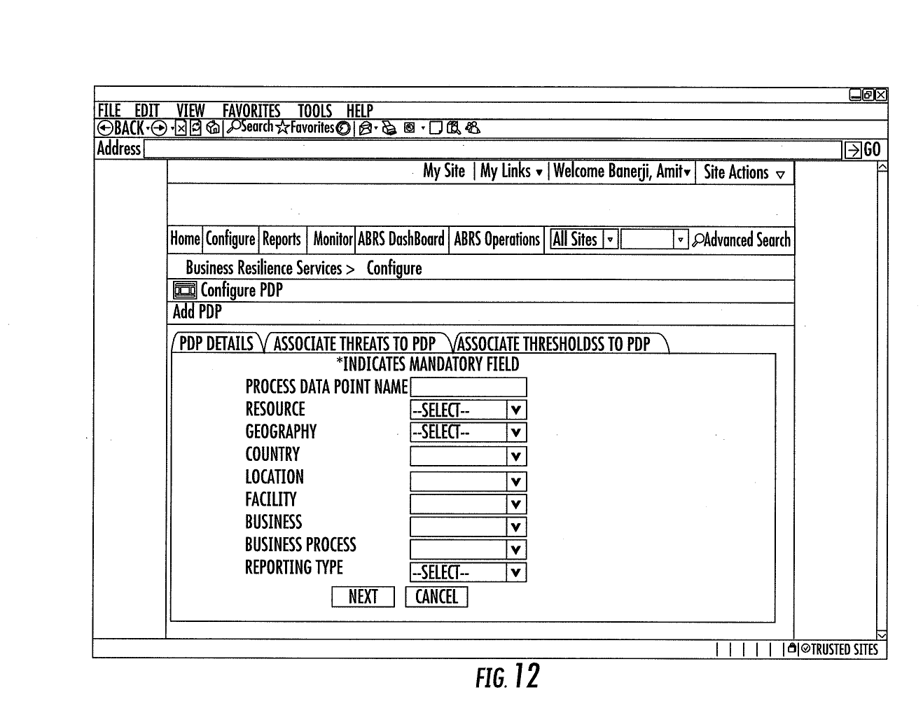

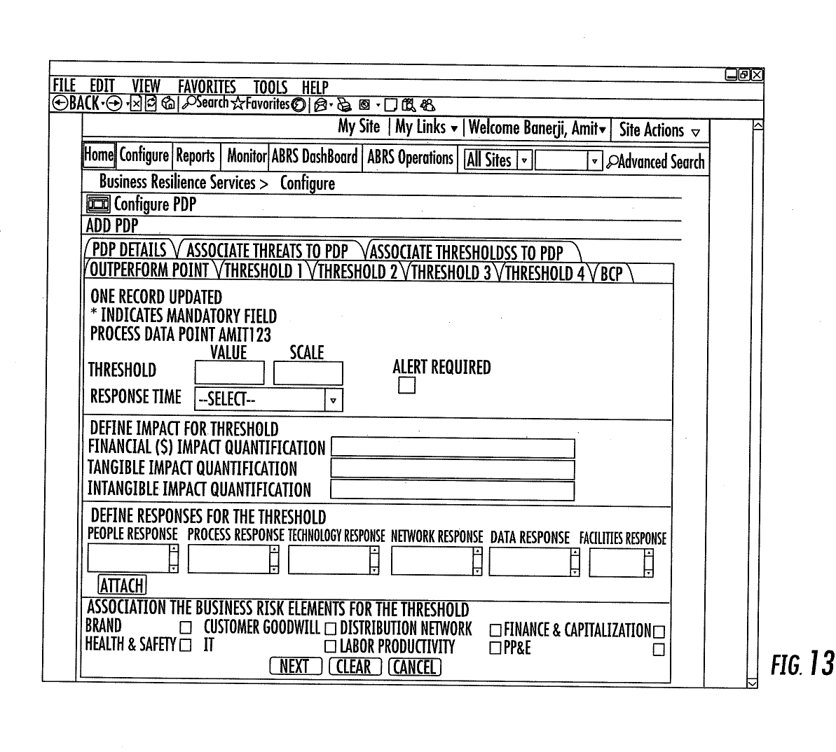

Upon entering the third orbit of the exemplary Risk Atom, threats and their resulting impact to the business are identified, quantified and segregated. As illustrated in FIG. 7, in the third orbit of the exemplary Risk Atom the impact to the business from a manifestation of any five primary threat areas is identified, classified and quantified within this grouping: environment; supply; demand; process and controls. The impact from any of the manifested threats can be measured in financial, tangible and/or intangible terms. A strong focus on the third orbit results in a better predictor and responder for the systems and methods of the present invention.

Within the fourth orbit of the exemplary Risk Atom, responses to threat manifestations or the situational event universe are mapped across the risk elements to complete the build of the Risk Atom. Risk elements represent, for example, the components of a company's supply chain that determines the overall corporate health. It is to be appreciated that supply chain components are exemplary and that whatever a client, business or organization wants them to be. Responses to business risk elements can involve one of four responses: avoidance; mitigation; transference and recovery. A response is generally to a threat based upon the Risk Atom's transit through the various threshold levels. Responses are performed so that the movement of a Risk Atom does not materially impact or affect the Risk Elements such brand, customer service, etc. A response to a specific force from the situational event universe may involve one or all of the response classifications within any risk element. The key to an effective and successful utilization of the Risk Atom model is identifying risk element responses that facilitate rapid company reactions in order to lessen realized risk and impact, as well as enhance the overall business resilience and continuity.

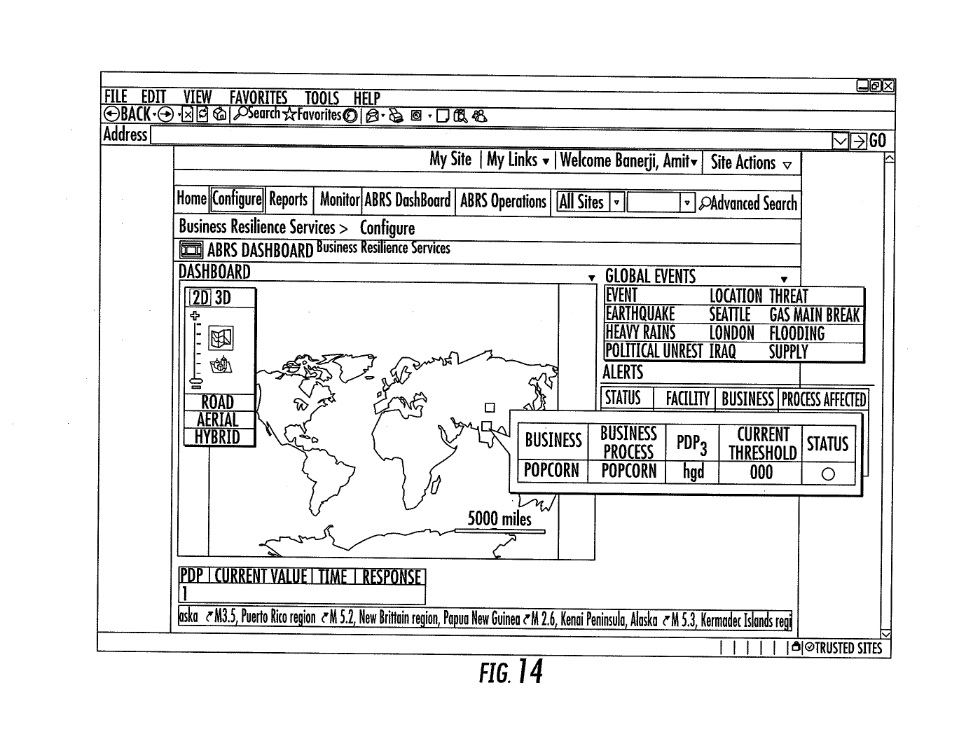

FIG. 9 shows an exemplary use of Risk Atom when certain levels of a response are enacted. As shown in FIG. 9, an exemplary Risk Atom begins its journey at Point A—stasis or equilibrium. A threat has impacted the Risk Atom and its performance measure continues to drop until it passes Threshold 1 and finds itself at Point B. At that point, the first response or series of responses are activated in the hopes of potentially avoiding any further performance degradation to the business process. The Risk Atom continues to fall and passes through Threshold 2. At Point C the second response or series of responses is activated in an attempt to mitigate any impact from the threat. The scenario continues to Point D where the third “resilience” response is activated.

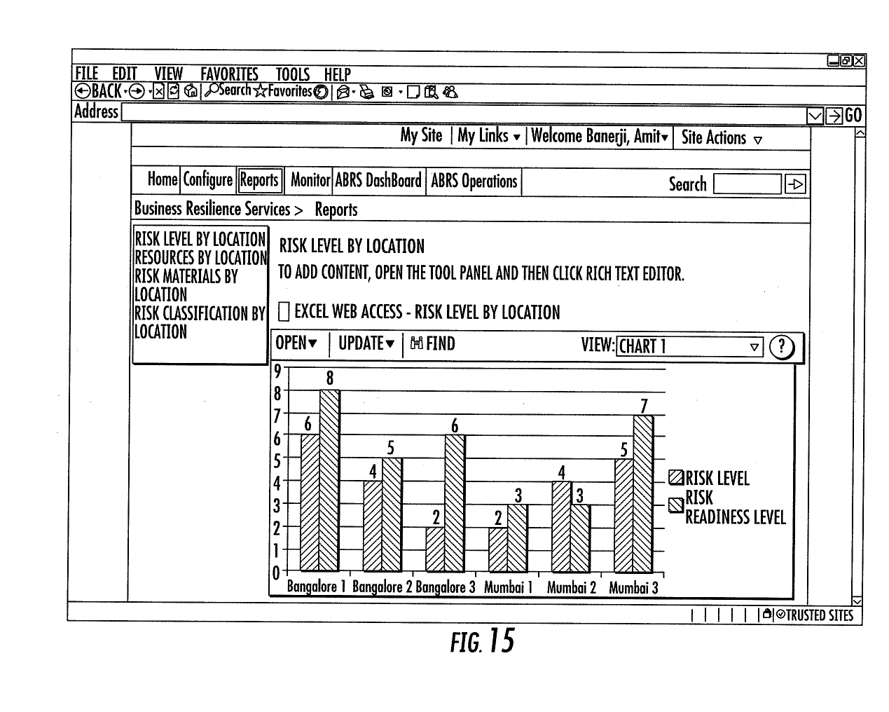

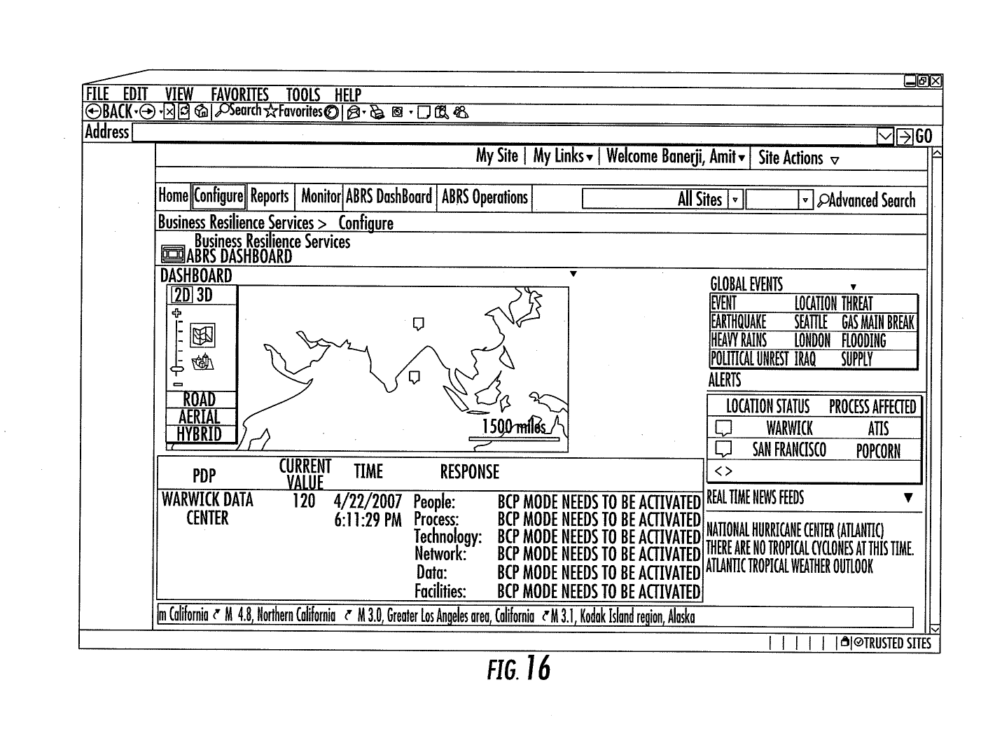

If the Risk Atom performance continues to fall towards the Targeted Service Level, the final response is to recover from the threat situation which means that the previous three responses did not rectify the fall of the Risk Atom and there could be a direct and negative impact on the company's “bottom line.” The concept of systems and methods of the present invention and the Risk Atom is to provide and act upon threats before they critically impact the business and cause potentially irreparable harm. From a systems view, the Risk Atom can be seen as part of the foundation for the presently inventive systems and methods as shown in FIG. 10.

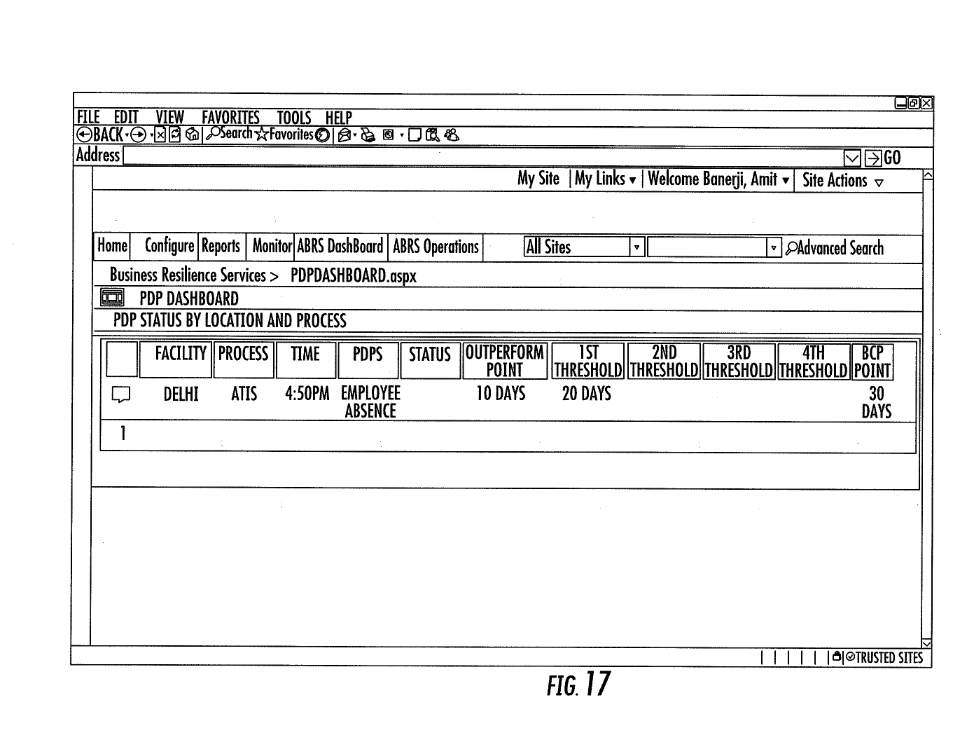

FIG. 11 shows how an overall monitoring system may continuously change to meet the client demands and the real world situational crises.

The business resilience lifecycle management approach provides a continuous improvement loop aimed at supporting the critical business processes and the enterprise assets necessary for the maintenance of revenue, earnings and shareholder value.

The business resilience design framework provides a construct to introduce new levels of automation and on-line services aimed at streamlining risk management. Additionally, business resilience systems and methods mature to include re-useable content libraries and best practices by Industry.

Certain government contractors may provide commercial offerings in emergency management, which can be easily confused with business resilience systems and methods disclosed herein. It will be important in this instance to differentiate between “resilience,” which is the ability to maintain shareholder value through sustained revenues and profitability no matter the crisis, as opposed to emergency management, which is the ability simply to recover from catastrophic events when they occur, absorbing the adverse impacts on revenue and profitability as best as possible.

Various systems and methods of the present invention utilize a holistic approach that combines services and technology. Embodiments of the present systems and methods utilize a tool set to allow entities to: span global business operations; identify and connect dependencies across both operational and geographic functions within an enterprise in order to orchestrate risk mitigation and response; create a business case for action by using risk mitigation to enhance visibility into business operations in a way that improves productivity, as documented by the Stanford University study; create an easy-to-access, inexpensive way of incorporating the services into existing operations without intense capital investment or disruptive reengineering of business process and legacy systems and allow a methodology that encourages continuous renewal of risk awareness, diagnosis and mitigation based on the on-line accessibility of the tool set and its ease-of-use.

Other important characteristics of select embodiments of the present systems and methods include that the capabilities are also differentiated from the existing market offerings through the following: technology enabled risk assessment methodology and tools that associate business risks with costs so that the business case for taking new measures to address the risk is clear, or the case to make no further investment is equally made and understood; profiling of people, assets, sites and suppliers associated with individual risks provides substantial new insight into business operations and dependencies; the comprehensive assessment of the risk mitigation and recovery methods to be enabled at the operating level of the business provides new insight to business efficiencies and dependencies for more thorough and effective planning; the linkage of roles and responsibilities in people profiles with specific alerts and action plans to be executed at the personnel level provides faster response and more efficient communications and collaboration among those impacted or empowered to act; action plan activities are automatically distributed based on clear chains of command and accountability; linkage to local government, federal government and even international stakeholder organizations are made equally accessible, based on the incident type or regulatory requirements; information on costs and activities are tracked in a way that allows for review and improvement on the actions taken to mitigate risk on a continuous basis and the risk tools themselves provide for self-assessment of current and future risks on-demand or as a routine practice across the organization.

In yet another embodiment of the present invention, tools and a methodology for integrating ongoing resilience assessment with continuous improvement capability across the full scope of enterprise processes—vs. today's tools: i.e. inventories of risks and point solutions. Clients obtain enabling process and technology for business resilience that 1) they cannot develop on their own at anywhere near the same TCO, 2) provides a means of continuous improvement they want, and/or 3) they have not envisioned but recognize they need.

In still another embodiment, the Risk Atom defines the certain applicable intersections of data and process necessary to identify the information sources and risk mitigation required to transform current processes into resilience requirements, stakeholder roles & responsibilities and action plans. It identifies client vulnerabilities in terms of their own corporate DNA. It provides the means for custom immunization, i.e. the identification and implementation of discrete building blocks necessary for resilience.

In still another embodiment, the systems and methods provides a standard framework and methodology for the on-going design and test of resilience solutions among enterprise BUs, geographies and related stakeholders, including government and community. It is the most holistic framework available today. It breaks down silos that clients acknowledge they cannot do on their own and it helps standardize methods of resilience assessment and solution development across the enterprise and extended value chain.

In still another embodiment of the present systems and methods provides clients the essential structure required for inculcating a culture of resilience. The Integrated Monitoring and Response capability provides the information and decision support needed for the client execution of resilient processes. It pulls it all together in terms of the Governance establishment of a leadership, strategy and chain-of-command with clear roles and responsibilities, together with ongoing monitoring and integrated response capability.

Embodiments in accordance with the present invention also may build proprietary assets to address cross-industry problems through the development of reusable methodologies and assets as well as industry specific capabilities. The offering leverages existing capabilities and expertise, as it is dependent on Security Practice, Supply Chain and Strategy expertise; SI workforce and BPO capabilities; existing internal risk assessment tools; and industry and process expertise. Embodiments of the present invention demonstrate high potential for generating incremental demand, specifically around significant transformational sales in the Supply Chain service line. In addition, other business units will also benefit from this approach. Finally, business resilience systems and methods incorporate a logical adjacent growth platform that uses a combination of internal and external capabilities, innovation and thought leadership, and a sales model that facilitates the gradual transition towards a steady and predictable managed service revenue model.

The foregoing embodiments are to be considered in all respects illustrative rather than limiting the invention described herein. The invention has been described with reference to certain exemplary embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An apparatus for monitoring business resilience, comprising:
a risk assessment component configured to compare an asset and a threat for each of a plurality of risks;
a prioritization component configured to prioritize and mitigate each of the plurality of risks;
a deployment component configured to monitor the threat and to communicate the prioritization component of a status of the threat; and
a continuous assessment component configured to modify at least one component to maintain shareholder value.

2. The apparatus of claim 1 wherein the assessment component is web-enabled.

3. The apparatus of claim 1 wherein the assessment component assesses the entire enterprise.

4. The apparatus of claim 1 wherein the prioritization component prioritizes risks and develops a mitigation strategy based on those risks.

5. The apparatus of claim 4 wherein the mitigation strategy includes monitoring, notifying and automated action plan dissemination and decision support.

6. The apparatus of claim 5 wherein the deployment component comprises deploying services in accordance with the mitigation strategy.

7. The apparatus of claim 1 wherein the continuous assessment component includes improving each of the risk assessment component, the prioritization component and the deployment component.

8. A method for monitoring and responding to risk elements, the method comprising the steps of:
activating a first orbit to affect at least one key performance indicator for a process data point;
activating a second orbit when the key performance indicator reaches a predetermined threshold; where the second orbit includes determining the appropriate business functions and the accompanying resources;
activating a third orbit being when the determination of the second orbit is completed; where the third orbit includes identifying threats and risks that are associated with the business functions and accompanying resources of the second orbit; and
activating a fourth orbit when the identification of the third orbit is completed; where the fourth orbit includes responding to the threats and risks of the third orbit.

9. The method of claim 8 where the first orbit is monitored manually.

10. The method of claim 8 where the first orbit is monitored by a computer.

11. The method of claim 8 where the process data point has a target value associated with the process data point.

12. The method of claim 11 where if the process data point has a value that is higher than the target value, the first orbit is activated.

13. The method of claim 8 where the business function is selected from the group consisting of information technology, finance, sales and manufacturing.

14. The method of claim 8 where the resource is selected from the group consisting of people, processes, technologies, networks, data and facilities.

15. The method of claim 8 where the threats may be categorized into one or more threats selected from the group consisting of environmental, supply, demand, process and controls.

16. The method of claim 8 where a response avoids, mitigates, transfers or recovers from a threat or risk.

17. A method of monitoring risks and threats in order to maintain business resilience, the method comprising:
activating a first orbit to affect at least one key performance indicator for a process data point;
activating at least one middle orbit to identify threats and risks associated with the process data point; and
activating a final orbit being when the at least one middle orbit has completed its identification; where the final orbit responds to the threats and risks of the at least one middle orbit.

18. The method of claim 17 where the at least one middle orbit includes a determining orbit, where the determining orbit determines the business functions and accompanying resources for the process data point prior to the middle orbit identifying threats and risks.

19. The method of claim 17 where the data tool includes a spreadsheet having business functions and accompanying resources along a vertical axis and includes an entry portion along a horizontal axis for information associated with each process data point at a pre-determined time interval.

20. The method of claim 19 where the data tool is a software program on a personal computer.

21. A computer-readable medium having computer-executable instructions to perform:
comparing an asset and a threat to determine at least one key performance indicator for a process data point;
identifying a plurality of risks associated with the process data point;
prioritizing the plurality of risks for mitigation;
monitoring the threat and providing a status of the threat; and
modifying a business process to maintain business resilience.
